(19) United States
(12) Patent Application Publication
(10) Pub. No.: US 2004/0255005 A1
(43) Pub. Date: Dec. 16, 2004

(54) Web server resident on a mobile computing device

(76) Inventor: David Spooner, Greenford (GB)

Correspondence Address: Richard C Woodbridge, Synnestvedt, Lechner & Woodbridge, PO Box 592, Princeton, NJ, 08542-0592, US

(21) Appl. No.: 10/487,643

(22) PCT Filed: Aug. 27, 2002
(86) PCT No.: PCT/GB02/03915

(30) Foreign Application Priority Data
Aug. 24, 2001 (GB) 0120712.5

(51) Int. Cl. G06F 15/16

(52) U.S. Cl. 709/218

(57) ABSTRACT

A mobile computing device comprising a web server; wherein the web server is capable of converting application specific data from a binary data format optimised for the device to a first agreed format which is a standard format not optimised for the device, in order to enable both (i) an application A, running on the mobile computing device and which can handle the standard format and also (ii) an application B, running on a further device remotely connected to the mobile computing device and which can also handle the standard I format, to read the application specific data stored on the mobile computing device. Converting application specific data stored on the mobile computing device in a native, proprietary binary format into an agreed standards based format, such as a mark-up language like HTML, makes that application specific data fully portable, a major advantage whilst mobile networks are expensive, and have reliability and latency issues.

### BACKGROUND TO THE INVENTION

1. Field of the Invention

This invention relates to a web server which is resident on a mobile computing device. A web server is a device or software which is capable of making available information in an agreed format, such as a mark-up language format, to a client, such as a web browser. A mobile computing device includes without limitation handheld computers, laptop computers, mobile telephones, personal organisers and wireless information devices.

2. Description of the Prior Art

Web servers are, traditionally, powerful non-mobile computers which store thousands or tens of thousands of information pages in HTML or WML format. Physically remote client computers can, using a browser, request, display and navigate through this information. Web servers in embedded devices are also known; for example, it is known to provide a web server on a printer to allow a printer to not only print pages of a document but also to facilitate interfacing to the printer.

To date, there have been some limited attempts to place a web server on a mobile computing device. For example, it is known to include a web server on a handheld computer for the limited purpose of enabling that computer to view web pages which have been transferred to the handheld computer from an internet connected PC; the local web server on the handheld computer in effect acts as a cache, enabling the user of the handheld computer to browse at leisure web pages which have earlier been downloaded using the internet connected PC and then transferred to the handheld device. The main data on the handheld computer (typically PIM (personal information management) data, including diary and contacts/address information) is not however accessible via the local web server, nor is that data made available to any remotely connected computing device via the local web server.

It is also known to provide an internet-based PIM application, which allows users to keep all of their PIM data on a remote web server, which they write to and browse over an internet connection from a PC. This approach has severe drawbacks however for users with mobile computing devices, because connections over mobile networks can not only be expensive, but also be unreliable and exhibit significant latency. There are also perceived data privacy issues relating to storing confidential, personal data on a remote web server.

### SUMMARY OF THE INVENTION

In a first aspect of the invention, there is a mobile computing device comprising a web server; wherein the web server is capable of converting application specific data from a binary data format optimised for the device to a first agreed format which is a standard format not optimised for the device, in order to enable both (k) an application A, running on the mobile computing device and which can handle the standard format and also (ii) an application B, running on a further device remotely connected to the mobile computing device and which can also handle the standard format, to read the application specific data stored on the mobile computing device.

The application specific data may be personal information management (“PIM”) data (e.g. contact lists, diary etc.), messages (e-mails, SMS etc.), word processed documents, sound files, image files etc. The further device may be a desktop PC or another mobile computing device. The agreed format may be specifically defined by either application A or B or be an implicit default or be negotiated between the requesting application A or B and the web server.

This approach leads to many significant advantages over the prior art. For example, converting application specific data stored on the mobile computing device in a native, proprietary binary format into an agreed standards based format, such as a mark-up language like HTML, makes that application specific data fully portable, a major advantage whilst mobile networks are expensive, and have reliability and latency issues.

This approach can also assuage data privacy issues relating to having sensitive data kept on a remote central server because sensitive data can now be kept on a mobile computing device, yet can readily be shared (i.e. made portable) with other devices. Hence, it overcomes the fundamental problems affecting the internet web site based approach of placing all PIM data on a remote web server.

Also, by accessing PIM information and messages etc., (i.e. the kinds of information one normally struggles to synchronise and keep up to date between a desktop and handheld computer) via the web server resident on the mobile computing device, sharing data between the further devices is simply a matter of allowing those devices to browse the data held on the web servers on the mobile computing device; there is no synchronisation per se as there are no multiple data sets. Browsing would not be possible were the data to be kept in its native format. With prior art approaches, synchronisation is a complex and necessary element.

The web server may also be capable of converting application specific data from a second agreed format to the binary data format in order to enable each application A and B to write or manipulate application specific data, which can then persist into the mobile device data storage. The first agreed format may be HTML where application A and B are browsers; the second agreed format could then be form data format. In some instances, the first and second agreed formats can also be the same. Not all application specific data needs to be manipulated though—for example, the data stored on the mobile computing device could be a voice mail, in which case there would be no purpose in being able to alter that voice mail from a remotely connected device.

Note that the client applications A and B accessing this application specific data may be the same kind of application as the application that ‘owns’ the application specific data, but may also be different. In a preferred implementation they are in fact different and are web browsers. Further, applications A and B do not have to access the application specific data at the same time or co-operate in any manner with each other, although they are capable of this. Finally, applications A and B are not able to read/render the application specific data in its native binary format.

Synchronisation may also be performed with implementations of the present invention and this is facilitated because synchronisation and backup configuration parameters may also be stored on the mobile computing device; desktop connectivity is therefore greatly simplified.

These parameters define what data is to be synchronised, when and how often to backup. Current connectivity solutions (e.g. PsiWin) are PC based and would interrogate a mobile computing device from the PC so that all the configuration information is stored on the PC and all the functionality (i.e. the acts of synchronisation or backup) are performed on the PC. The present invention however may allow a user to place these synchronisation and backup parameters on the mobile computing device and to use the mobile computing device to produce, in mark-up language (e.g. HTML), a user interface for the configuration of these functions. This UI can then be accessed from a remote PC. This allows a user to perform synchronisation and backup functions from any PC rather than just the user's own.

In an implementation of the present invention, the web server operates in effect as a light weight middleware layer, allowing other remotely connected devices (i.e. applications A and B) not only to read data held on a given mobile computing device but also to write new data to that device. Further, because this middleware server translates data in the format native to the application that owns that data to, for example, generic mark-up language format and vice-versa, it allows any remotely connected user to amend, delete or add to the data stored on the mobile computing device by sending form data to the server. Using one device (PC or mobile computing device) to directly amend PIM data (for example) stored on a web server in another, remotely connected mobile computing device, is not possible in the prior art.

The web server comprises plug-in modules connected in a pipeline, the pipeline terminating in multiple data conversion plug-in modules each dynamically selectable to retrieve data from (or in some cases also to write data to) a different source of the application specific data, each data conversion module capable of converting data between one or more native binary data formats and the agreed formats. Dynamic selection means that the web server selects the appropriate plug-in based on the request without the need for any manual user configuration. Different data conversion plug-ins are capable of translating one or more different native formats (e.g. different PIM applications; different messaging clients) both into and out from the agreed format, such as generic mark-up language. One application of the present invention is to allow mobile computing devices to become personal information transmitters, with peer to peer data conversations over ad hoc networks.

Further, the web server may interact with a browser (an example of application A) resident on the mobile computing device such that the browser provides the user interface to the application specific data stored on the mobile computing device. The browser on the mobile computing device can in effect become the complete and entire UI, since all PIM data, PIM applications, messaging applications and communications screens and related functions and features can be converted into a mark-up language understood by the browser, such as HTML. And since the UI uses data written in a mark-up language, a template defining the UI (and hence controlling the organisation and selection of the application specific data used to construct the UI) can be readily changed/updated/customised over the air to take into account user preferences/enable greater product differentiation/personality: the present invention therefore enables a form of software enabled, mass customisable faceplate.

In addition, the further device which is remotely connected to the mobile computing device may display (i.e. in application B) data stored on the mobile computing device in a format determined by the further device. Sharing data between devices should therefore be easier as there should be no problems with incompatible data formats or applications: data is simply in a generic, standard format, such as HTML, and hence viewable in any compatible application, such as a browser. Multiple remote client devices are therefore able to use the markup language formatted data derived from the native data held on a source mobile computing device stored on a mobile computing device in the optimal manner that they can, without the web server on the source device having to know anything about the display capabilities of those other client devices. In addition, the web server can also become cognisant of the browser capabilities of the other client devices using information sent from those other client devices and can therefore optionally optimise the formatted data for a target display device.

The mobile computing device may also be remotely connected to the further device over a WAN, local area wireless network or piconet. As it is generally easier and more reliable to access data across a piconet (e.g. a Bluetooth™ network) rather than across a mobile WAN, placing the mark up format data to be shared in a given circumstance (e.g. exchanging business details in a meeting) actually in that piconet (rather than outside it and in a remote server accessed over the internet), with the source mobile computing device providing the web server, should lead to quicker, cheaper and more robust data delivery in many situations. Remote connection over a WAN, such as the internet or a wireless WAN (e.g. GPRS or 3G) is also possible.

Another possible feature is that the web server may alter its behaviour or operation in dependence on the location or environment of the mobile computing device. For example, when the mobile computing device determines that it is solely in a network with high security clearance, it could make available highly sensitive application specific data (e.g. messages stored on the messaging client, documents etc.) But when in a public, low security network, it could only make a small set of uncontroversial data available (e.g. name of the device owner).

The term ‘web server’ used in this specification should be expansively construed to cover any kind of data or content server, and is not limited to a conventional web server using specifically HTTP. Hence, it covers other protocols too, such as RTP (Real Time Protocol), in which case the web server would be more commonly regarded as a streaming server. OBEX and WAP and examples of other kinds of protocols which may be handled. SOAP and XML remote procedure calls can also be provided by the web server. The web server in the present invention, whilst capable of converting the application specific data to, for example, a mark up format, may additionally also be capable of outputting a simple text string without any formatting. The text string output can then be used by another application (for example on the host device—application A, or the connected device—application B) which can then format the text string data appropriately. The ‘web server’ hence exploits a novel insight that all data transmission protocols define either binary streams or sets of tagged values, and that a generic ‘web’ server can be constructed which can handle any protocol with either kind of protocol format, in combination with a protocol specific plug-in.

In a second aspect, there is a method of enabling an application A running on a mobile computing device and an application B running on a further device which is remotely connected to the mobile computing device to read application specific data which is stored on the mobile computing device, comprising the step of:

converting, at a web server resident on the mobile computing device, the application specific data from a binary data format optimised for the device to a first agreed format which is a standard format not optimised for the device but which can be handled by both applications A and B.

In a third aspect, there is computer software when stored on a carrier medium, the software enabling a mobile computing device and associated further device to perform the method of the second aspect when running on the mobile computing device.

In a final aspect, there is computer software when transmitted over a network, the software enabling a mobile computing device and associated further device to perform the method of the second aspect when running on the mobile computing device.

Further details of the invention are stated in the appended claims.

### BRIEF DESCRIPTION OF THE DRAWINGS

The present invention will be described with reference to:

FIG. 1 which is a schematic overview of the present invention;

FIG. 2, which shows a schematic depiction of the internal plug-in modules and pipelines used in an implementation of the present invention called m-Surf;

FIG. 3 which shows an optional network configuration including a mobile computing device running m-Surf, and

FIG. 4 which shows a schematic of the routing software optionally used in the FIG. 3 system.

### DETAILED DESCRIPTION OF THE PREFERRED IMPLEMENTATION

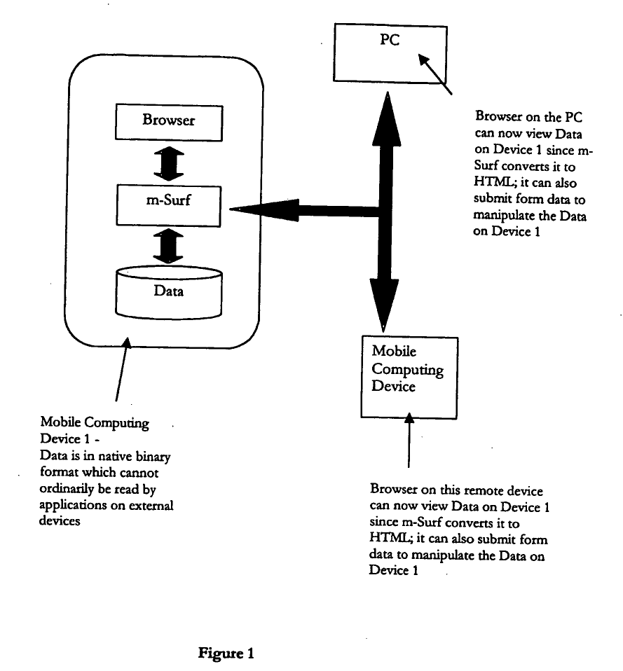

The present invention is implemented as m-Surf™ from Intuwave Limited of London, United Kingdom. m-Surf is a light weight HTTP server resident on a mobile computing device that can be used as a standards based means of accessing application specific data held on a mobile device, hence allowing remote viewing and manipulation of data from connected devices (e.g. other mobile computing devices, desktop PCs) that would otherwise be restricted to the device. FIG. 1 shows this schematically. It is ‘standards-based’ because it converts application specific data which is in one or more native proprietary binary data formats (e.g. optimised for the compact storage and low power consumption requirements of mobile computing devices) on the device (e.g. Symbian OS format, or Microsoft Pocket PC format) to a standards-based format which can be rendered by standards based applications running on the device (e.g. a web browser if the standards based format is HTML) and also by external devices connected by wire or a wireless network.

Some simplified background on the general operation of web servers may be helpful as an introduction:

HTTP servers receive requests for ‘pages’ of data.

The ‘page’ is identified by a text string known as a URL.

The ‘page’ may be the contents of a file identified by the URL.

The ‘page’ may be the result of some query performed by a process run on a per request basis

The ‘page’ may be of any type. Common types include HTML, JPEG, GIF, AIF, WAV

The server can authenticate the client for security

The server can run over secure sockets for additional security or use s-http.

Though pages are usually fetched from the server with a “Get” request, data can also be submitted with a “Post” request

HTTP servers can store unique identifiers (cookies) client side to identify clients and therefore aid the persistence of user data between sessions.

XML formats including SyncML can run over HTTP, they are just another type of ‘page’.

A HTTP reference can be found at http://www.w3.org/Protocols/Specs.html

m-Surf meets 2 primary requirements:

To appear to external clients to be a HTTP server that is compliant with the http protocol v1.1.

To internally manage requests in a protocol agnostic manner so that different protocols can be used in parallel to the initial HTTP protocol

Other requirements (some of which are a result of the 2 just listed)

To accept for processing the verbs “HEAD”, “GET”, “POST”, “PUT”, “DELETE”, “OPTIONS”, “TRACE”—note that the RESULT of these verbs depends on the resource (URL) being referred to

To be able to support simultaneous client sessions

To be extendable by adding DLLs without needing to re-code existing modules

To provide CGI services or equivalent

Return ANY content type and size

Server Static content (i.e. html documents from the epoc file system etc)

To log the HTTP requests and responses to a text file.

To be browsable locally from the Symbian OS web browser, and also remotely from browsers such as Microsoft Internet Explorer.

The design of mSurf 2.0 is modular and based on the idea of a pipeline of simpler plug-in modules that each perform a discrete part of the system. The modules are loaded and managed by a framework called mStream. mStream provides pipes and data sharing objects. It provides a mechanism to load and link the appropriate modules together to form a logical pipeline. This structure allows individual modules to be replaced or used in alternate systems, leading to efficient and rapid design of new systems.

The outer most component in the system is considered a gateway into this pipeline and is another reusable component that is used to provide access to various other mStream based pipelines. The inner most component is a data conversion plug-in module that is determined dynamically based on the URL and specifics of the request for application specific data passed into m-Surf. For example it may be a plug-in module that retrieves data from specific sources (i.e. restricted sub-set of the device filing system) PIM contact information, or messages, or word processed documents etc and converts them to a required standards based format or a module that calls into additional layers to perform some other application specific query. Multiple inner most modules will be present in a given system.

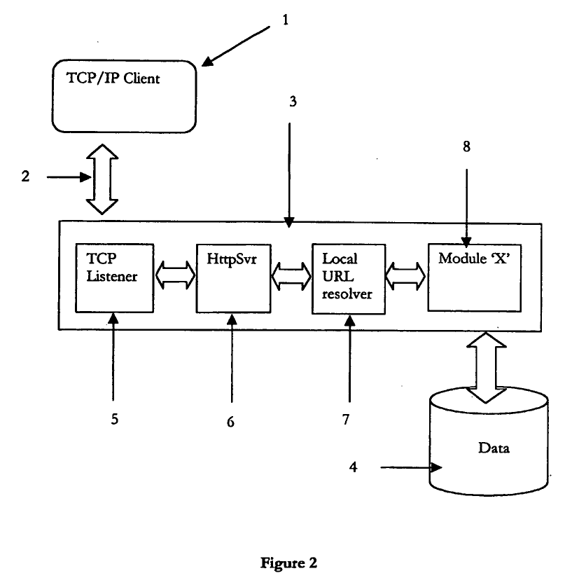

The pipeline is shown at FIG. 2. A web browser application (the TCP/IP client) 1 sends data requests 2 defining what data it needs, the desired format etc. to the m-Surf web server indicated generally at 3. The agreed format can be explicitly requested by the browser application or an implicit default selection. The m-Surf web server 3 in essence takes application specific data stored on the device in a proprietary and compact format from the relevant sources in memory 4 and converts it into the agreed format encoded using HTTP and then passes it back to the requesting component (in this case web browser 1) for processing/rendering.

Key features are that

(a) the location of the requesting application/component 1 is not material. It can be within the device itself, or external to it. There can be multiple such applications.

(b) m-Surf can output back to the requesting component data in any agreed standard format—e.g. HTML if to be rendered in a web browser, but possibly a text string for other applications etc.

(c) Browser application 1 can also write data to the memory 4 or alter existing data. Hence, a web browser on a device could be used to display diary information stored on the device; the user can add new calendar entries via the browser which are sent as form data to m-Surf which then converts them into the proprietary native data format used in the device to store calendar data.

The components within m-Surf 3 are, briefly, a TcpListener 5 which listens out for incoming data requests and then passes them as a logical data stream to HttpSvr 6, which reads the incoming data requests and converts them to an internal structure which it can manipulate, encoding its output as HTTP. Local URL resolver 7 then works out to which particular Module ‘X’ 8 it should send the request to and ensures that it gets data back in the agreed format. Module ‘X’ 8 then acquires the relevant data and converts it into the agreed format (e.g. HTML, text string, image file formats such as JPEG, or sound file formats such as WAV etc.). This is passed back up through m-Surf and then sent to the requesting application 1. The final path to application 1 may be external over a piconet or a WAN such as a GPRS or 3G cellular network.

The various parts of the pipeline in more detail are:

TcpListener 5—this reusable component is configured to listen on a specific TCP port (usually 80). As connections are made an object is created inside the module that reads and writes from the new connection. This object starts a new instance of the pre-selected module for this port (in this case HttpSvr.dll) and passes it a pair of pipes over which it will exchange request data. It also passes a collection (bundle) of properties which HttpSvr can use to find details about the TCP connection. The TcpListener module serves as an adapter between the external TCP bi-directional data stream and the internal pair of uni-directional pipes that are fed into HttpSvr.

HttpSvr 6—Each instance of HttpSvr reads from its input pipe and parses the possibly multiple text HTTP request into a collection (bundle) of header values and a possibly null request content stream. It then uses mStream to create an instance of LocalUrlResolver and passes it a pair of pipes and the collection of headers/merged with the collection it received from TcpListener. It passes the request content to LocalUrlResover that then returns a response content via the pipes. It formats this response into a HTTP response header and content and returns the result to TcpListener. Note that HttpSvr may parse several individual requests from a single data stream and will create a new instance of LocalUrlResolver to process each of these requests. The splitting of requests and concatenation of responses is internal to HttpSvr.

In overview, HttpSvr therefore performs the following functions:

to parse the input stream header and convert all recognised headers into input parameters.

to parse the input stream body and convert to a binary stream containing just that data

to additionally convert and create additional headers with ‘more useful’ formats

to read the response parameters and data from module X and format into a http request

to log a summary of the request and result to a text log file

to reply to the client in the protocol version of the request i.e. http 1.0/1.1

to gracefully handle the client (i/o layer) disconnecting

to support the trace command without recourse to the lower layers

to allow the I/O layer to supply client address information for the request

LocalUrlResolver 7—this reusable component takes as its input a collection (bundle) of headers and a possibly null request stream. It examines the URL and uses a configurable decision process as to which module it needs to pass the request to for processing. It loads the appropriate module and delegates processing to that module.

Module ‘X’ 8—this processes the request headers and content and returns a response. For example a module called IFileRequest is able to retrieve files from a restricted subset of the device filing system, and to dynamically generate HTML directory listings. More generally, Module X converts application specific data from a proprietary compact native data format into an agreed, standard format that can be handled/rendered by another application on the device (e.g. a web browser) or by another device.

MODULE ‘X’ iFileRequest functions are therefore:

uses access control DLL to map input path to physical path and to query for permissions

to “GET”/“PUT”/“DELETE” files where permitted by the access DLL

to get directory listings as permitted by the access DLL and return as html pages

to support “HEAD” verb (file modified date only) where permitted by the access DLL

to where possible open files as read only deny none and where that failed to retry

Module X is a plug in; a device will have multiple such modules and will dynamically select the appropriate module when a request for data handled by the module is received by m-Surf. Multiple modules can be active and can hence deliver data from several different data sources into a requesting application.

This also allows user interface customization separately from and in addition to raw data retrieval. For example, a web browser running on the device can request via m-Surf data from all of the different data sources that a given user (or a device supplier or network operator) might define as being desirable in a start up home page (e.g. contacts, diary, device function menu, link to operator's home page). This browser becomes in effect the entire graphical user interface for the device. It is straightforward to add corporate logos to the graphical user interface, allowing the device to be branded for a particular device manufacturer, network operator or corporate owner. A master template can be used to define the overall structure of the UI; this initiates multiple requests for data from several sources to build up the UI. The UI could for example consist of a user defined list of top level menu items (e.g. contacts and dairy) and could also incorporate a user defined menu hierarchy. The user interface to the device can also be dynamically changed or update or customised over the air to take into account user preferences or enable greater product differentiation.

Each of these modules 5, 6, 7, 8 can alternatively have its input/output pipes redirected to or from test files or other sources, though typically they will be used as in the above situation.

While not specifically part of m-Surf, one extension to the system has been a simple template module that can call plug in modules and then format the returned data using template files to produce HTML and other formats of content.

By modularizing the design, alternative and related technologies such as WAP and SOAP can also be integrated in a structured yet efficient manner.

Miscellaneous implementation details now follow: m-Surf is a c++HTTP server that runs on the Symbian OS (formerly EPOC) device (m-Surf also runs on a Pocket PC device by means of a porting library).

The server uses the existing Symbian OS sockets implementation

The server normally run as a process without any UI.

The server logs request, responses and operational data to a database that can be viewed by an auxiliary application.

The server is responsible for parsing the request stream and formatting and handling the reply.

The server (using an additional DLL) provides authentication such that plug-ins can control access to ‘page’ data.

The server manages cookies.

The server runs as at least 2 threads. The first uses active objects to parse and format requests. The other thread(s) loads and calls the plug-ins. This allows the plug-ins to block or run synchronously without stalling the primary thread.

The same plug-ins can be reused in a WAP or OBEX server.

The source code does not assume a narrow or Unicode platform and is recompilable as either with minimal changes.

The server uses plug-in DLLs to fetch or generate the ‘pages’. Examples of possible plug-in that could be written would be DLLs to:

query agenda and contacts and display the data as XML or html pages.

run scripts in Java or OPL,

provide data or commands to a client side engine (Java applets, flash plug-ins etc).

return the contents of files on the device.

process SyncML data or even drive a synchronisation

control and configure the http server itself

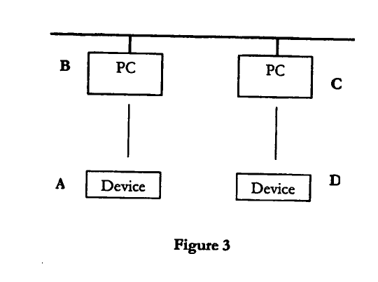

m-Surf is particularly effective when used in conjunction with a data routing technology called m-Router, also from Intuwave Limited. m-Router allows a browser on a device (A in FIG. 3) or a PC (B) to access a m-Surf http server on a device (D) via its host PC (C), where m-Router connects A to B and C to D. m-Router is described in more detail in Appendix 1.

Appendix 1

m-Router Overview

m-Router provides mobile computing devices with TCP/IP & UDP connections via direct wired or wireless links to a host PC. It consists of software which runs only on the host PC. No changes or additions are required to software installed on the attached devices.

m-Router is an easy to use, standards based PC implementation of a firewall and PPP server that is used to enable mobile devices to access the host PC and if reachable the internet/network to which the PC is connected. By using PPP as the local link protocol between a mobile device and the PC, connectivity based solutions for these devices can be reused for both over the air and desktop based scenarios. By providing bearer plug-ins (an extensible hardware abstraction layer) and protocol plug-ins (a configurable protocol stack layer) bearers such as USB and Bluetooth can be used where previously connectivity was either solely RS232 based, or was different for each bearer. The solution provided by m-Router allows all hardware bearers to be treated with equality and therefore eases the development effort as generally only one protocol—TCP/IP—needs to be understood by the developer. Since one of the main paradigms in m-Router is automatic configuration and transparency for the consumer, this delivers the advantages of standards based connectivity software but in a manner that is not restricted to experienced system mangers.

M-Router is currently offered in two versions, m-Router Runtime and m-Router Developer.

m-Router allows a browser on a device (A in FIG. 3) or a PC (B) to access an HTTP server on a device (D) via its host PC (C), where m-Router connects A to B and C to D. The HTTP server on device D is m-Surf.

The Developer version also contains a user interface, which allows the following parameters to be set

Listening port number

Log file name and directory

Enable/disable COM ports

Enter software registration number

The interface also allows various parameters to be displayed while the software is running.

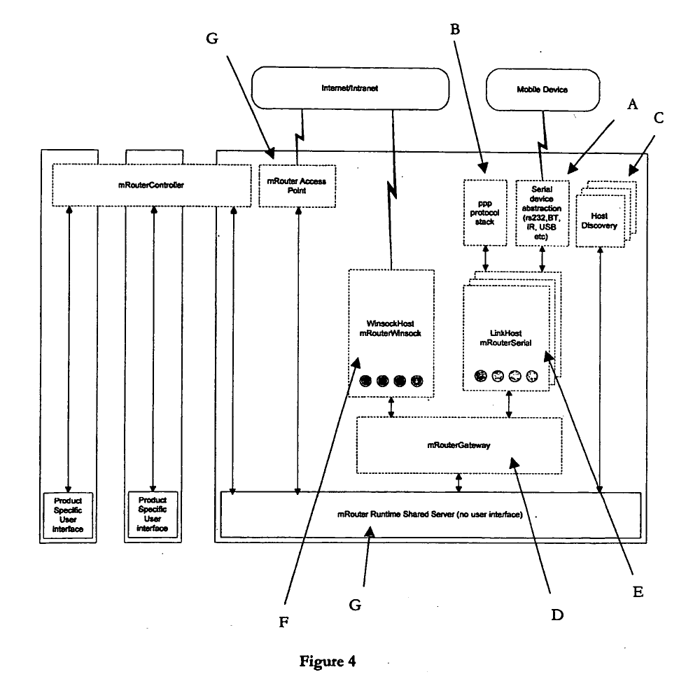

In more detail, m-Router is a moderately complex collection of sub systems. FIG. 4 is an overview of how these sub systems interrelate.

One or more products may include/use m-Router. These all share a single instance of a shared runtime (m-RouterRuntime.exe) that exposes its state and allows manipulation via a shared memory component called m-RouterController.

Within m-RouterRuntime G a set of host discovery modules C are loaded. These all expose a common interface and are extendable. These modules monitor for new pieces of hardware becoming available/unavailable, such as for example a relevant USB device being inserted, a Bluetooth serial port being added/removed. When a change is detected they notify m-RouterRuntime G via a call-back interface and they are then asked to enumerate the hardware bearer devices ‘currently available’. These are defined by bearer plug-ins A, which each define an available hardware bearer (e.g. USB, direct cable, IR, Bluetooth etc.) The plug-ins act as serial device abstraction layers.

MRouterGateway D manages a internal set of imaginary hosts (sometimes referred to as host handlers). Each of these hosts has a non-routable IP address associated with it. Most of these hosts are created at the request of m-RouterRuntime in response to changes in the list of ‘currently available’ hardware bearers A. A class called LinkHost E (contained within m-RouterSerial module) implements these hosts. Instances of this class use additional modules that abstract the various hardware bearers A as serial data streams. They read and write raw data bytes from connected devices and use a PPP stack B to convert the assumed PPP data to an internal sequence of packets/frames. There is a single instance of a host called Winsock Host F that interfaces with the PCs TCP sockets framework. Frames of data are passed around the system by m-RouterGateway D, between source and destination endpoints specified in the frames. All the various hosts internally manage endpoints for these frames. These end points are called port handlers. In Winsock Host F, these ports (shown as grey circles) correspond to socket connections on the pc (possibly to other machines on the internet or alternatively to applications on the same PC as m-Router). In the Link Hosts E these ports correspond to sockets on the connected mobile device and the contents of frames to and from the remote ports are transferred via PPP over the abstracted hardware bearer.

Various statistics regarding the current available hosts are ‘published’ via m-RouterController so that external user interface components can display wiggly links, check boxes and other forms of feedback to the user if desired. Other statistics are made available for internal use to m-RouterRuntime, which in developer configurations can load m-RouterPropPages.dll to display byte level diagnostic logging. P Mobile devices connect through m-Router to the PC and any network it is connected to. Additionally mobile devices can choose to connect via TCP to a service called m-RouterAccessPoint PC. If they choose to do this then they pass a series of properties to m-RouterAccessPoint G and are considered to have logged in. m-RouterAccessPoint G exposes a programming API to enumerate connected devices and their associated properties. MRouterAccessPoint G also allows programmatic creation of routes to ports on connected mobile devices. These devices being part of the non-routable network implemented by m-Router would otherwise be unreachable by the PC. m-RouterAccesspoint G can create local PC socket listeners that will forward data to a target port on a selected device.

MRouterWinsock F acts as the interface between the sockets API on the PC and hosts and ports internal to m-Router. It performs simple network address translation and therefore behaves as a simple firewall. MRouterAccessPoint G allows programmatic access to devices hidden behind this wall.

1. A mobile computing device comprising a web server; wherein the web server is capable of converting application specific data from a binary data format optimised for the device to a first agreed format which is a standard format not optimised for the device, in order to enable both (i) an application A, running on the mobile computing device and which can handle the standard format and also (ii) an application B, running on a further device remotely connected to the mobile computing device and which can also handle the standard format, to read the application specific data stored on the mobile computing device.

2. The mobile computing device of claim 1 in which the web server is capable of converting application specific data from a second agreed format to the binary data format in order to enable each application A and B to write or manipulate application specific data.

3. The mobile computing device of claim 1 in which the web server comprises plug-in modules connected in a pipeline, the pipeline terminating in multiple data conversion modules each dynamically selectable to retrieve data from a different source of the application specific data, each data conversion module capable of converting data between one or more binary data formats and the first agreed format.

4. The mobile computing device of claim 1 in which the first agreed format is a mark up language format and the application A on both the device and the application B on the further device is a web browser.

5. The mobile computing device of claim 4 in which the browser resident on the mobile computing device provides a graphical user interface which brings together application specific data from several different sources.

6. The mobile computing device of claim 5 in which the browser becomes the complete user interface to the device.

7. The mobile computing device of claim 6 in which the user interface to the device can be changed or update or customised over the air to take into account user preferences or enable greater product differentiation.

8. The mobile computing device of claim 1 in which the first agreed format is a text string format for use in an application A or B which then formats the text string data appropriately.

9. The mobile computing device of claim 2 in which the second agreed format is form data format.

10. The mobile computing device of claim 1 in which the mobile computing device is remotely connectable to the further device over a WAN, or a local area network or a piconet.

11. The mobile computing device of claim 1 in which the web server is programmed to alter its behaviour or operation in dependence on the location or environment of the mobile computing device.

12. The mobile computing device of claim 11 in which, only when the mobile computing device determines that it is solely in a network with high security clearance, is it programmed to make available highly sensitive application specific data.

13. The mobile computing device of claim 1 in which the application specific data is one of the following types: personal information management (“PIM”) data, messages, word processor documents, image files and sound files.

14. The mobile computing device of claim 1 which also stores synchronisation and backup configuration parameters.

15. A method of enabling an application A running on a mobile computing device and an application B running on a further device which is remotely connected to the mobile computing device to read application specific data which is stored on the mobile computing device, comprising the step of:
converting, at a web server resident on the mobile computing device, the application specific data from a binary data format optimised for the device to a first agreed format which is a standard format not optimised for the device but which can be handled by both applications A and B.

16. The method of claim 15 in which either application is enabled to write new application specific data or manipulate the application specific data, comprising the further steps of:
converting, at the web server resident on the mobile computing device, the new or manipulated application specific data from a second agreed format to the binary data format; and
storing the new or manipulated data in the binary data format.

17. The method of claim 15 in which the step of conversion is preceded by the step of selecting an appropriate data conversion plug-in module, the available data conversion modules being each dynamically selectable to retrieve data from a different source of application specific data.

18. The method of claim 15 comprising the step of the web server interacting with a browser resident on the mobile computing device and the first agreed format is a mark up language format that can be rendered by the web browser.

19. The method of claim 18 comprising the step of the browser resident on the mobile computing device providing a graphical interface which brings together application specific data from several different sources.

20. The method of claim 19 comprising the step of the browser on the mobile computing device operating as the complete user interface to the device.

21. The method of claim 20 comprising the further step of changing or customising the user interface to the device over the air to take into account user preferences or enable greater product differentiation.

22. The method of claim 16 in which the second agreed format is form data format.

23. The method of claim 15 comprising the further step of outputting the application specific data in text string format from the web server, the text string format data being used in an application A or B which formats the data appropriately.

24. The method of claim 15 in which the further device, which is remotely connected to the mobile computing device, displays data stored on the mobile computing device in a format determined by the further device.

25. The method of claim 15 comprising the step of remotely connecting the mobile computing device to the further device over a WAN, or a local area network or a piconet.

26. The method of claim 15 comprising the step of the web server altering its behaviour or operation in dependence on the location or environment of the mobile computing device.

27. The method of claim 26 in which, only if the mobile computing device determines that it is solely in a network with high security clearance, does it make available highly sensitive application specific data.

28. The method of claim 15 in which the application specific data is one of the following types: personal information management (“PIM”) data, messages, word processed documents, image files and sound files.

29. The method of claim 15 comprising the step of the mobile computing device storing synchronisation and backup configuration parameters.

30. Computer software when stored on a carrier medium, the software enabling a mobile computing device and associated further device to perform the method of claim 15 when running on the mobile computing device.

31. Computer software when transmitted over a network, the software enabling a mobile computing device and associated further device to perform the method of claim 15 when running on the mobile computing device.
